(19) United States
(12) Patent Application Publication
(10) Pub. No.: US 2011/0176711 A1
(43) Pub. Date: Jul. 21, 2011

(54) METHODS, APPARATUSES & COMPUTER PROGRAM PRODUCTS FOR FACILITATING PROGRESSIVE DISPLAY OF MULTI-PLANAR RECONSTRUCTIONS

(76) Inventor: Radu Catalin Bocirnea, New Westminster (CA)

(21) Appl. No.: 12/691,240

(22) Filed: Jan. 21, 2010

(51) Int. Cl. G06K 9/00

(52) U.S. Cl. 382/128

(57) ABSTRACT

An apparatus is provided for efficiently receiving a set of medical images from a device. The apparatus includes a processor configured to receive a selection for a medical image(s) of a set of medical images and send a request to a device for transfer of the medical images of the set. The request includes information instructing the device to transfer a subset of the set of images first. The processor is also configured to receive the subset of images in a reduced-quality based on information in the request and display the subset of images. Additionally, the processor is configured to subsequently receive the medical images of the set in a high quality based on an order specifying a sequence that the medical images of the set are to be transferred and display the high quality medical images of the set. Corresponding computer program products and methods are also provided.

### TECHNOLOGICAL FIELD

Embodiments of the present invention relate generally to a mechanism of more efficiently rendering multi-planar reconstructions (MPRs) and, more particularly, relate to a method, apparatus and computer program product for efficiently transferring medical images of a dataset to a device for diagnosis of one or more of the images prior to receipt of the entire dataset of images.

### BACKGROUND

Advances in processor, networking and other related technologies have led to increased networked computing and abundant availability of content on private and public networks. Users may access the available content from computing devices remote from the content storage and interact with the content using their local computing device. A particularly relevant example is medical imaging, in which radiologists and other physicians may access and manipulate medical images as part of diagnostic interpretation. These medical images may be part of a volume of data images (e.g., radiographic images) to be reformatted in various planes or may be part of volumetric data or representations of structures such as for example parts of a human body. In this regard, the medical images may be images of the body generated from radiography, ultrasound, magnetic resonance imaging or any other medical imaging technique. The medical images may be received by devices such as for example workstations of the radiologists or other physicians from a remote computing device such as a server. These workstations may render multi-planar reconstructions by displaying one or more two-dimensional images of the volumetric data (e.g., images).

At present, rendering of multi-planar reconstructions on a device such as a workstation typically requires the transfer of large datasets (e.g., images), potentially consisting of thousands of images. It should be pointed out that the time required for a server to transfer these images to the workstation may be significant (e.g., tens of seconds) and may vary depending on the size of the dataset and conditions of a network. However, waiting for the entire dataset to be transferred to the workstation before displaying the multi-planar reconstruction may be undesirable since radiologists and other physicians may desire to examine the images associated with the multi-planar reconstruction as soon as possible. For instance, the radiologists and other physicians may desire to display the multi-planar reconstruction as soon as possible so that they can begin diagnosing the associated images.

Existing solutions for transferring medical images to devices of physicians and for rendering the MPRs on these devices in a timely manner suffer from drawbacks. For instance, typically a server is utilized to render the MPRs and to transfer the rendered image to a device of a physician in order to achieve a short-display time. However, this approach is typically unsuitable for networks that have a high latency and low bandwidth (e.g., low bandwidth capacity) since the network latency (e.g., delay) and/or low network bandwidth may slow the effective transfer speed of the rendered images and hence the displaying of the MPRs on devices of the physicians. Additionally, the number of physician devices that may utilize the server simultaneously for displaying the MPRs are typically limited by the server's capacity. This limitation in the server's capacity may also cause delay in the transfer of the MPRs and the rendering of the MPRs on the devices of the physicians.

In view of the foregoing drawbacks, it may be desirable to provide a mechanism that more efficiently transfers medical images to devices so that the devices may more efficiently render multi-planar reconstructions in a timely manner.

### BRIEF SUMMARY

A method, apparatus and computer program product are therefore provided that enable provision of an efficient manner in which to transfer a set of images (e.g., medical images such as for e.g., Digital Imaging and Communications in Medicine (DICOM) images) to a device.

The exemplary embodiments may facilitate transfer of a sparse set (Sₛ) of images of a dataset of images in response to receipt of a selection for one or more images. The sparse set of images may be a subset of the images of an entire dataset of images defined by a three-dimensional volume. The images of the sparse set may be received by a device in a reduced-quality (e.g., preview quality) prior to the receipt of all the images of the dataset. In this regard, the exemplary embodiments may render a multi-planar reconstruction(s) of the images of the sparse set so that the images may be viewed by a user. In this manner, the exemplary embodiments may minimize the overhead of transferring all the images of a dataset to a device before a user (e.g., physician) may be able to view desired images. It should be pointed out that the exemplary embodiments may, but need not, facilitate display of the reduced-quality (e.g., preview quality) images within two seconds of a user's request or selection for one or more images. The immediate access to view one or more reduced-quality images (e.g., preview-quality images) may allow a user to navigate or manipulate (e.g., changing orientation, rendering parameters and a point(s)-of-interest) the images associated with a multi-planar reconstruction(s) prior to the entire dataset of images being transferred.

After a device receives the sparse set of images, the exemplary embodiments may facilitate transfer of all the images in the dataset. The transfer of all of the images in the dataset may be transferred in a high quality that is sufficient for a user to diagnose these images. It should be pointed out that the transfer of the images in the dataset may be based on a transfer order generated by the exemplary embodiments which may specify the sequence in which the images are to be transferred to a device. In this regard, the exemplary embodiments may generate the transfer order of the images based in part on a proximity to a user-defined or selected point(s)-of-interest. As such, the exemplary embodiments may facilitate transfer of images closer to the point-of-interest with a high quality (e.g., diagnostic display quality) before transfer of images that are peripheral to the proximity of the point-of-interest.

In this regard, the transfer of images proximal to a user-indicated region or point-of-interest may be prioritized so that diagnostic-quality rendering may be quickly achieved at the indicated point-of-interest. As such, diagnosis of one or more images as well as diagnosis of a corresponding person (e.g., patient) associated with the images may commence before the entire dataset of images has been transferred to a device.

Upon receipt of high quality images of the dataset of images, the exemplary embodiments may replace the reduced-quality images with corresponding high quality images. Additionally, the exemplary embodiments may provide a mechanism for tracking or monitoring a point(s)-of-interest (which may be displayed) and may dynamically adjust the transfer order of the images on the basis of the tracked point(s)-of-interest. For instance, when the exemplary embodiments determine that a new point-of-interest is selected by a user or that a point-of-interest has changed, the exemplary embodiments may monitor and detect this new or changed point-of-interest and may dynamically generate a new transfer order.

In one exemplary embodiment, a method for efficiently receiving a set of medical images from a device is provided. The method may include receiving a selection for one or more medical images of a set of medical images and sending a request to a device for transfer of the medical images of the set. The request may include information instructing the device to transfer a subset of the medical images of the set first. The method may further include receiving the subset of medical images in a reduced-quality based on information in the request and displaying the subset of medical images in the reduced-quality. Additionally, the method may include subsequently receiving each of the medical images of the set in a high quality based on an order specifying a sequence in which the medical images of the set are to be transferred and displaying the medical images of the set in the high quality.

In another exemplary embodiment, an apparatus for efficiently receiving a set of medical images from a device is provided. The apparatus includes a processor configured to receive a selection for one or more medical images of a set of medical images and send a request to a device for transfer of the medical images of the set. The request may include information instructing the device to transfer a subset of the medical images of the set first. The processor may also receive the subset of medical images in a reduced-quality based on information in the request and display the subset of medical images in the reduced-quality. Additionally, the processor may subsequently receive each of the medical images of the set in a high quality based on an order specifying a sequence in which the medical images of the set are to be transferred and display the medical images of the set in the high quality.

In yet another exemplary embodiment, a computer program product for efficiently receiving a set of medical images from a device is provided. The computer program product may include at least one computer-readable storage medium having computer-executable program code instructions stored therein. The computer-executable program code instructions may include program code instructions for receiving a selection for one or more medical images of a set of medical images and sending a request to a device for transfer of the medical images of the set. The request may include information instructing the device to transfer a subset of the medical images of the set first. The program code instructions may receive the subset of medical images in a reduced-quality based on information in the request and display the subset of medical images in the reduced-quality. Additionally, the program code instructions may subsequently receive each of the medical images of the set in a high quality based on an order specifying a sequence in which the medical images of the set are to be transferred and display the medical images of the set in the high quality.

Embodiments of the invention may provide a method, apparatus and computer program product for facilitating receipt of high quality images of a dataset of images prior to receipt of the entire dataset of images. As a result, device users may enjoy improvements in diagnosing the images since the user may not be required to wait on the receipt of entire set of images in order to begin diagnosis.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a system according to an exemplary embodiment of the invention;

FIG. 2 is a schematic block diagram of a computing device according to an exemplary embodiment of the invention;

FIG. 3 is a schematic block diagram of a communication device according to an exemplary embodiment of the invention;

FIG. 4 is a diagram of a graphical representation of three-dimensional volumetric data according to an exemplary embodiment of the invention;

FIG. 5 is a graphical representation of a multi-planar reconstruction rendering according to an exemplary embodiment of the invention;

FIG. 6 is a diagram of a graphical representation illustrating a sparse set of multi-planar reconstructions according to an exemplary embodiment;

FIG. 7 is a diagram of a graphical representation of a distance between a point-of-interest and the intersection between a plane and an image according to an exemplary embodiment;

FIG. 8 is a diagram of a graphical representation illustrating the order in which images of a multi-planar reconstruction may be transferred according to an exemplary embodiment; and

FIG. 9 is a flowchart of a method for rendering multi-planar reconstructions according to an exemplary embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

### General Overview

In general, according to various embodiments of the invention, methods, apparatuses, systems and computer program products are provided for varying the quality of one or more images in a dataset of images (e.g., DICOM images). In this regard, the exemplary embodiments may generate one or more reduced-quality images which may be displayed. Upon receipt of improved quality images the reduced-quality images may be replaced with the improved-quality images. The best-available-quality of the images may replace corresponding improved-quality images. The best-available-quality of the images may be displayed and may be used for diagnostic purposes.

Additionally, the exemplary embodiments may receive a subset of medical images of a dataset from a device in which the subset of images may include reduced-quality images. The reduced-quality images may be displayed upon receipt. The remainder of the images of the dataset may be subsequently received and displayed in a progressive manner.

The exemplary embodiments may also continuously monitor a user-indicated point(s)-of-interest and in this regard the exemplary embodiments may replace reduced-quality images in the proximity of the point(s)-of-interest with higher quality images that may be used for diagnostic purposes. In this manner, the density of the images in the proximity of the point(s)-of-interest may be increased at a greater rate than the density of the images in peripheral areas.

### General System Architecture

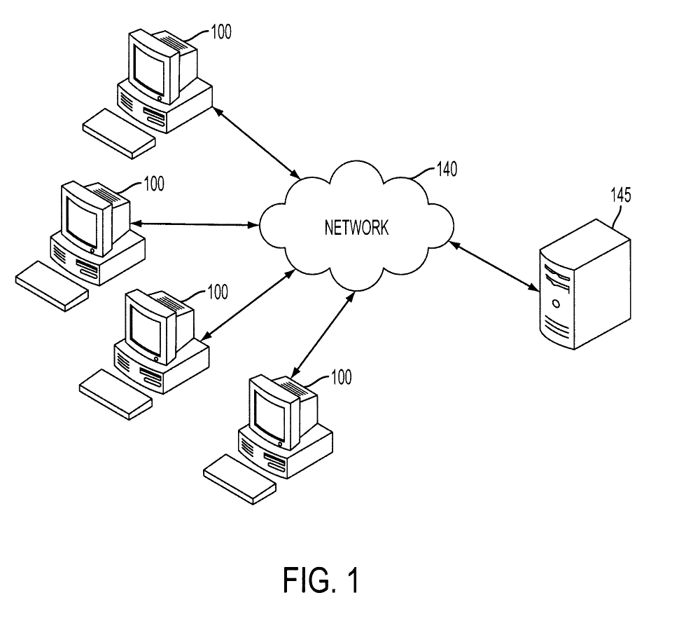

Reference is now made to FIG. 1, which is a block diagram of an overall system that would benefit from exemplary embodiments of the invention. As shown in FIG. 1, the system may include one or more computing devices 100 (e.g., personal computers, computer workstations, laptops, personal digital assistants and the like, etc.) which may access one or more network entities such as for example a communication device 145 (e.g., a server), or any other similar network entity, over a network 140, such as a wired local area network (LAN) or a wireless local area network (WLAN), a metropolitan network (MAN) and/or a wide area network (WAN) (e.g., the Internet). While four computing devices 100 (also referred to herein as client devices) are shown in FIG. 1, it should be pointed out that any suitable number of computing devices may be part of the system of FIG. 1. In this regard, the communication device 145 is capable of receiving data from and transmitting data to the computing devices 100 via network 140.

In an exemplary embodiment, the communication device 145 may send one or more medical images such as for example Digital Imaging and Communications in Medicine (DICOM) images to any of the computing devices 100. The medical images may relate to images of one or more parts (e.g., lungs) of a human body. The medical images as referred to herein may, but need not, be generated by computed tomography (CT), magnetic resonance (MR), radiography, ultrasound, or any other suitable modality. It should be pointed out that the medical images referred to herein may represent anatomic slices and be part of a volume of data which, for example, may be reformatted by multi-planar reconstruction in various planes or rendered as volumetric two-dimensional representations of structures such as one or more parts of a human body, as described more fully below. The slices may, but need not, have different depths with different thicknesses. In this regard, the computing devices 100 may render the multi-planar reconstructions so that the medical images may be shown on a display of the computing devices. In an exemplary embodiment, the medical images of the MPR may be displayed in two-dimensions by the computing devices 100.

### Computing Device

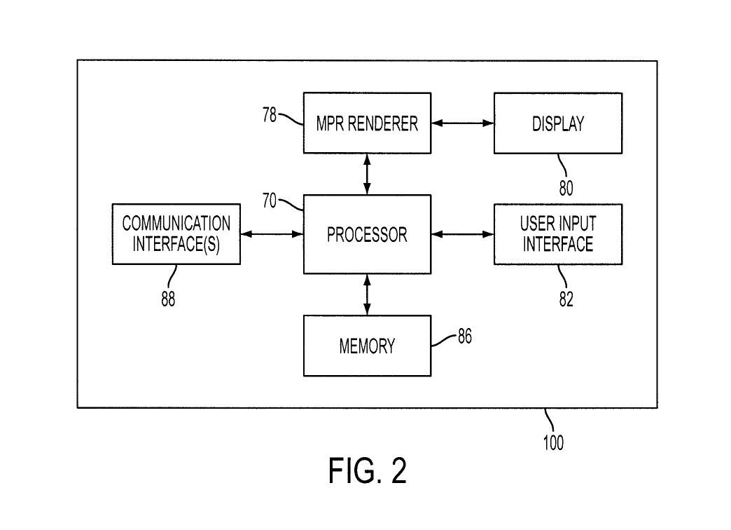

FIG. 2 illustrates a block diagram of a computing device according to an exemplary embodiment of the invention. The computing device 100 may, but need not, be a network entity such as for example, a server or may be a client device. The computing device 100 includes various means for performing one or more functions in accordance with exemplary embodiments of the invention, including those more particularly shown and described herein. It should be understood, however, that one or more of the computing devices may include alternative means for performing one or more like functions, without departing from the spirit and scope of the invention. More particularly, for example, as shown in FIG. 2, the computing device may include a processor 70 connected to a memory 86. The memory may comprise volatile and/or non-volatile memory, and typically stores content (media content), data, information or the like.

For example, the memory may store content transmitted from, and/or received by, the computing device. In an exemplary embodiment, the memory 86 may store one or more medical images (e.g., DICOM medical images). The medical images may be generated by computed tomography (CT), magnetic resonance (MR), radiography, ultrasound, or any other suitable modality and may relate to one or more parts of a human body, as described above.

Also for example, the memory 86 typically stores client applications, instructions or the like for execution by the processor 70 to perform steps associated with operation of the computing device in accordance with embodiments of the invention. As explained below, for example, the memory 86 may store one or more client application(s) such as for example software (e.g., computer code).

The processor 70 may be embodied in a variety of ways. For instance, the processor 70 may be embodied as a controller, coprocessor, microprocessor of other processing devices including integrated circuits such as for example an application specific integrated circuit (ASIC), a field programmable gate array (FPGA). In an exemplary embodiment, the processor may execute instructions stored in the memory 86 or otherwise accessible to the processor 70.

The computing device 100 may include one or more logic elements for performing various functions of one or more client application(s). In an exemplary embodiment, the computing device 100 may execute the client application(s). The logic elements performing the functions of one or more client applications can be embodied in an integrated circuit assembly including one or more integrated circuits (e.g., an ASIC, FPGA or the like) integral or otherwise in communication with a respective network entity (e.g., computing system, client, server, etc.) or more particularly, for example, a processor 70 of the respective network entity.

In addition to the memory 86, the processor 70 may also be connected to at least one interface or other means for displaying, transmitting and/or receiving data, content or the like. The interface(s) can include at least one communication interface 88 or other means for transmitting and/or receiving data, content or the like. In this regard, the communication interface 88 may include, for example, an antenna and supporting hardware and/or software for enabling communications with a wireless communication network. For example, the communication interface(s) may include a first communication interface for connecting to a first network, and a second communication interface for connecting to a second network. In this regard, the computing device is capable of communicating with other electronic devices (e.g., other communication devices 100 and communication device 145) over one or more networks (e.g., network 140) such as a Local Area Network (LAN), wireless LAN (WLAN), Wide Area Network (WAN), Wireless Wide Area Network (WWAN), the Internet, or the like. Alternatively, the communication interface can support a wired connection with the respective network. In an exemplary embodiment, the computing device 100 may receive one or more medical images (e.g., a set of medical images) from a device(s) (e.g., communication device 145) via the communication interface 88.

In addition to the communication interface(s), the interface(s) may also include at least one user interface that may include one or more earphones and/or speakers, a display 80, and/or a user input interface 82. The user input interface, in turn, may comprise any of a number of devices allowing the computing device to receive data from a user, such as a microphone, a keypad, keyboard, a touch display, a joystick, image capture device, pointing device (e.g., mouse), stylus or other input device. In an exemplary embodiment, one or more medical images may be shown on the display 80 and a user (e.g., a physician) may utilize the user input interface 82 to select one or more points-of-interest (POIs) on the medical images. For instance, the user may utilize a pointing device (e.g., mouse) or the like to select POIs of an image. Additionally, the user may select a POI(s) by using a stylus, pen, finger or the like to contact an area of one or more images on a touch display of the user input interface 82. It should also be pointed out that selection of a point(s)-of-interest may be performed by an eye-tracking mechanism such as, for example, tracking a user's point of gaze. The points-of interest may, but need not, be areas of the images that the user would like to evaluate or examine. For instance, the user may select a point(s)-of-interest on one or more medical images for diagnostic purposes.

In an exemplary embodiment, the processor 70 may in communication with and may otherwise control a multi-planar reconstruction (MPR) renderer 78. The MPR renderer 78 may be any means such as a device or circuitry operating in accordance with software or otherwise embodied in hardware or a combination of hardware and software thereby configuring the device or circuitry (e.g. a processor or controller) to perform the corresponding functions of the MPR renderer 78 as described below. In examples in which software is employed, a device or circuitry (e.g., processor 70 in one example) executing the software forms the structure associated with such means. As such, for example the MPR renderer 78 may be configured to provide among other things, for the rendering of multi-planar reconstructions associated with the medical images so that medical images may be displayed. Additionally, the MPR renderer 78 may reconstruct an area(s) or point(s)-of-interest of an image(s) in multiple planes so that the point(s)-of-interest may be displayed.

The MPR renderer 78 may also vary the quality of one or more medical images (e.g., DICOM images) in a dataset to generate respective reduced-quality medical images. It should be pointed out that these medical images may be received from a device such as, for example, communication device 145. In an exemplary embodiment, once the medical images are received from a device (e.g., communication device 145) the processor 70 of the computing device may feed the medical images to the MPR renderer 78. The MPR renderer 78 may also instruct the display 80 to show the reduced-quality medical image(s). In an exemplary embodiment, the reduced-quality medical image(s) may be an image(s) of a sufficient quality for a preview of the image(s) on a display (e.g., display 80). The preview of the reduced-quality images may be used for navigation purposes or manipulation of the images such as for example changing orientation of the images, zooming in or out of a view of the images, navigating back and forth between images and selecting points-of-interests on the images.

In response to receiving additional medical images of a dataset from the communication device 145, the MPR renderer 78 may replace the reduced-quality image(s) with an improved-quality image(s). The MPR renderer 78 may also instruct the display 80 to show the improved-quality image. As additional images of a dataset are received from the communication device 145, the MPR renderer 78 may replace the improved-quality image(s) with a diagnostic-quality image(s) which may be used for diagnostic purposes. It should be pointed out that the MPR renderer 78 may instruct the display 80 to show the best-available quality image. In this regard, a user (e.g., physician) of computing device 100 may utilize the diagnostic-quality image(s) to diagnose a medical condition of a person (e.g., patient).

In order to facilitate display of the medical images of a multi-planar reconstruction, the MPR renderer 78 may utilize a sparse representation of a dataset of images. As referred to herein a sparse representation may be a subset of images of a dataset. In this regard, the MPR renderer 78 may render the subset of images and may subsequently render the remainder of the images of the dataset in a progressive manner. It should be pointed out that the MPR renderer 78 may render the remainder of the images of the dataset in a progressive manner as the images are received by the computing device 100 from the communication device 145. By rendering a subset of the images of the dataset, via the MPR renderer 78, a user may select a point(s)-of-interest prior to receipt of the entire dataset of images. As such, diagnosis of the image(s) associated with the point(s)-of-interest may commence before receipt of the entire dataset of images. This may be beneficial to a user(s) (e.g., a physician(s)) that does not wish to wait on receipt of all of the images of the dataset in order to examine areas of interest. Additionally, the MPR renderer 78 may minimize the overhead associated with transferring the entire dataset of images to the computing device 100. Minimizing the overhead associated with transferring an entire dataset of images may be beneficial in networks experiencing high latency and low bandwidth since it may reduce the load on the resources of the network.

It should also be pointed out that the MPR renderer 78 may continuously monitor or track a user indicated point-of-interest. In this regard, when a user changes a point-of-interest, the MPR renderer 78 may detect this change and may dynamically adjust the MPR rendering of the medical images. The MPR renderer 78 may dynamically adjust the MPR rendering by replacing the reduced-quality images in the proximity of the point(s)-of-interest with diagnostic-quality images. In this manner, the density of the images in the proximity of the point-of-interest may be increased at a greater rate than the density of images in other peripheral areas.

Additionally or alternatively, when a point(s)-of-interest is changed, the MPR renderer 78 may send a request to the communication device 145 to transfer images of the dataset in areas in the proximity of the point(s)-of-interest before transferring images in peripheral areas of the images. In this regard, images closer to the point(s)-of-interest may be rendered by the MPR renderer 78 before images that are farther away from the point(s)-of-interest. As such, the MPR renderer 78 may allow a user to examine images and provide a diagnosis before the entire dataset of images is received by the computing device 100. In this manner, the MPR renderer 78 may efficiently render a dataset of medical images and may reduce the load on the resources (e.g., a processor such as for e.g., processor 70) of a device.

### Communication Device

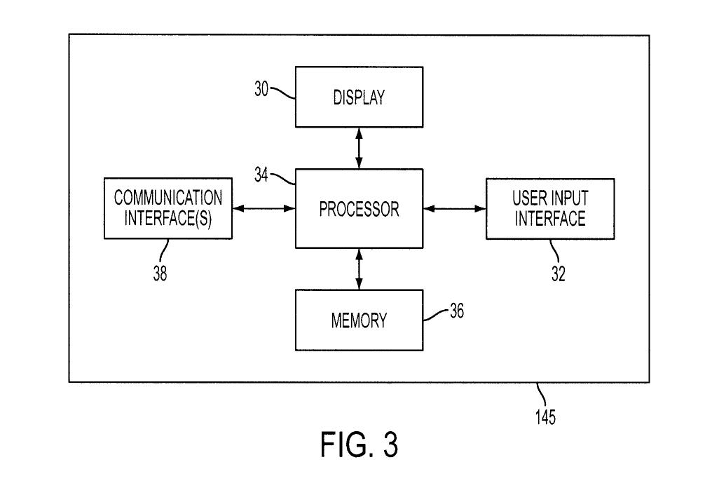

Referring now to FIG. 3, a block diagram of a communication device shown in accordance with an exemplary embodiment of the invention is provided. The communication device is capable of operating as server or other network entity. As shown in FIG. 3, the communication device 145 may include a processor 34 connected to a memory device 36. The memory device 36 may comprise volatile and/or non-volatile memory, and may store content, information, data or the like. For example, the memory device 36 may store one or more images such as, for example, medical images (e.g., DICOM images). Additionally, the memory device 36 typically stores content transmitted from, and/or received by, the communication device 145. Additionally, the memory device 36 may store client applications (e.g., software), algorithms, instructions or the like for the processor 34 to perform steps associated with operation of the communication device 145.

The communication device 145 may also include a processor 34 that may be connected to at least one communication interface 38 or other means for displaying, transmitting and/or receiving data, content, information or the like. In this regard, the communication interface 38 may be capable of connecting to one or more networks. In an exemplary embodiment, the communication device 145 may send one or more medical images to any of the computing devices 100 so that the computing devices 100 may render MPRs and display corresponding medical images. In an exemplary embodiment, the communication device 145 may receive instructions (e.g., a transfer order) from the computing devices regarding the manner in which to send the medical images, as described more fully below.

The communication device 145 may also include at least one user input interface 32 that may include one or more speakers, a display 30, and/or any other suitable devices. For instance, the user input interface 32 may include any of a number of devices allowing the communication device to receive data from a user, such as a keyboard, a keypad, mouse, a microphone, a touch screen display, or any other input device.

### Exemplary System Operation

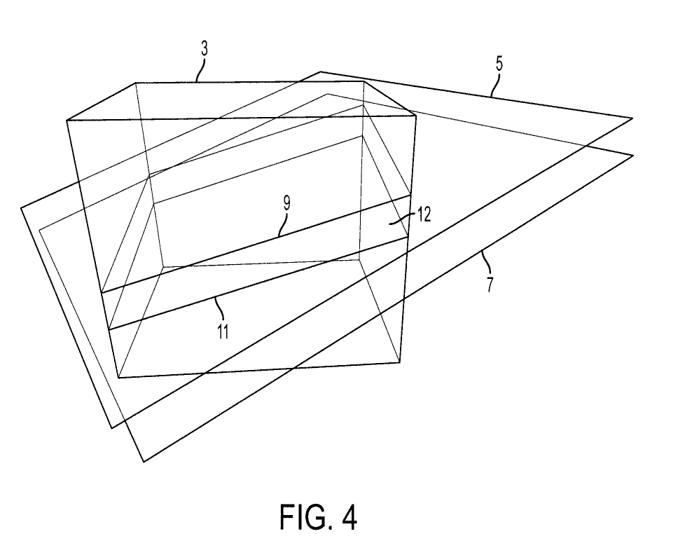

Reference will now be made to FIGS. 4-8, which show graphical representations of a three-dimensional volume V, images associated with an MPR(s), a sparse set of images associated with an MPR(s) to be transferred, and a mechanism for generating an order in which to transfer one or more images of a dataset according to exemplary embodiments. With respect to FIGS. 4-8, it should be pointed out that a plane 5 (also referred to herein as P₁) may be a plane that contains the cross section C₁ V_{MPR} 12 described below and shown in FIG. 4 and that plane 7 (also referred to herein as P₂) may be a plane that contains the cross section C₂ of V_{MPR} 12 also described below and shown in FIG. 4.

a. Definition of a Three-Dimension Volume of Images

Referring now to FIG. 4, a graphical representation of a three-dimensional volume of images according to an exemplary embodiment is provided. It should be pointed out that a set S of parallel images (e.g., DICOM images) denoted as I₁ . . . Iₙ (S={Iᵢ|1<=I<=n}) may define the three-dimensional volume 3 (also referred to herein as volume). As shown in FIG. 4, the three-dimensional volume 3 may be a cuboid. As also shown in FIG. 4, two parallel planes 5, 7 (also referred to herein as parallel planes P₁ and P₂, respectively) may intersect the volume 3 and may form cross sections 9 and 11 (also referred to herein as cross sections C₁ and C₂).

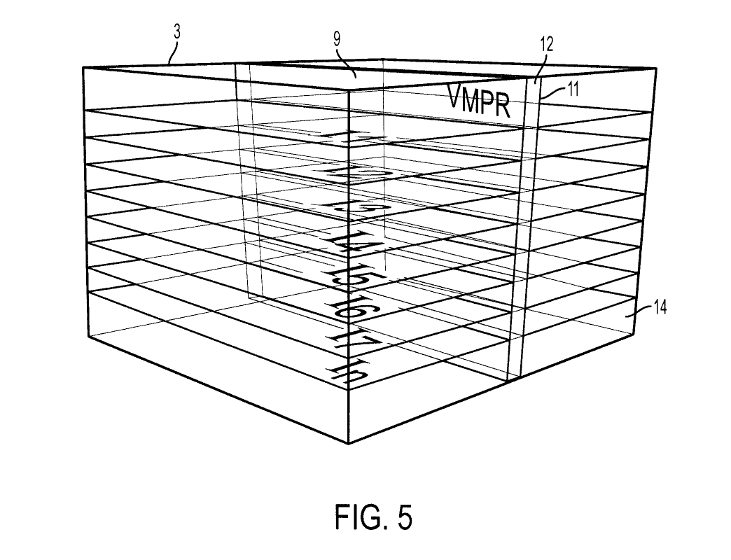

It should be pointed out that the volume 3 may have an acquisition plane (not shown). As referred to herein, the acquisition plane may be any one of the infinity of planes (not shown) parallel to the plane containing an image such as for example image I₁ (See e.g., FIG. 5).

Additionally, as referred to herein, an MPR rendering may be a two-dimensional isometric projection of a V_{MPR} slice 12 bounded by cross sections 9 and 11 on a plane parallel with plane 5 (e.g., plane P₁) and plane 7 (e.g., plane P₂). The MPR rendering may be generated by MPR renderer 78. It should be pointed out that given two non-intersecting surfaces S₁ and S₂ (not shown) intersecting volume 3 and forming cross sections C_{c1} and C_{c2} (not shown), a curved MPR rendering may be a two-dimensional projection of a V_{CMPR} slice (not shown) bounded by C_{c1} and C_{c2}. In this regard, a mechanism of projection may vary depending on a clinical purpose of an MPR rendering. In an exemplary embodiment, the MPR rendering referred to herein may, but need not, require data from more than one original image(s) (e.g., original DICOM image(s)) of the set S of images. It should be pointed out that the MPR renderer 78 may generate the volume 3 and the components of volume 3 shown in FIG. 4 and described above.

As described more fully below, the progressive display of images associated with multi-planar reconstructions may be achieved by providing the MPR renderer 78 with datasets of images of increasing quality or fidelity.

b. Graphical Representation of Images Associated with MPR(s)

Referring now to FIG. 5, a graphical representation of images (e.g., medical images) associated with a multi-planar reconstruction(s) according to an exemplary embodiment is provided. It should be pointed out that FIG. 5 may relate to a general scenario in which the MPR renderer 78 may receive all of the images of a dataset of images such as images (e.g., DICOM images) I₁ to 1ₙ of the set S which defines the volume 3. The MPR renderer 78 may receive the images I₁ to Iₙ from a device such as communication device 145. The MPR renderer 78 may arrange or reformat the images I₁ to 1ₙ of the set S such that the center planes of the images are perpendicular to V_{MPR} slice 12. The images I₁ to Iₙ may represent anatomic slices rendered as volumetric two-dimensional representations of structures such as one or more parts of a human body. The images I₁ to Iₙ may, but need not, have different depths with different thicknesses.

In this example, the MPR renderer 78 may render the V_{MPR} slice 12 so that the received images I₁ to Iₙ of set S may be shown on a display (e.g., display 80) of a computing device 100. In this manner, the MPR renderer 78 may instruct the display 80 to show the images I₁ to Iₙ in two-dimensions. Although not shown in FIG. 5, it should be pointed out that plane P₁ may be perpendicular to an acquisition plane and a side 14 of the volume 3.

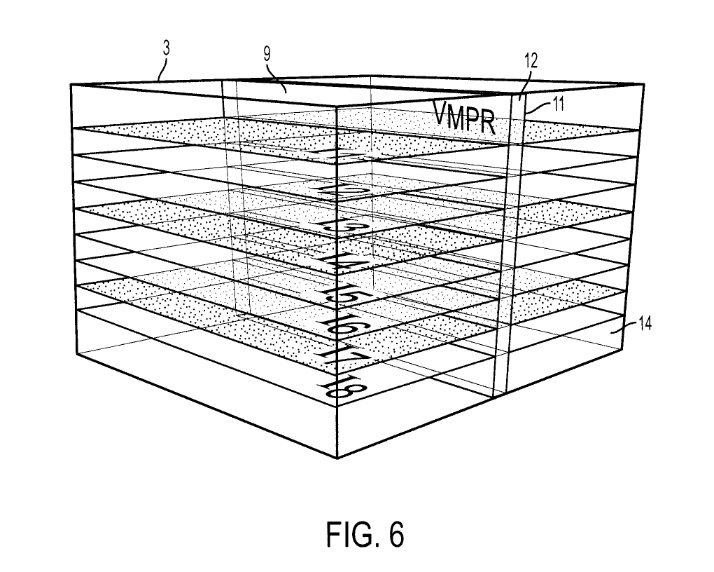

While the example of FIG. 5 illustrates the general scenario in which the MPR renderer 78 may render the set of images I₁ to Iₙ of set S, for example, it should be pointed out that the MPR renderer 78 of the exemplary embodiments utilizes efficient techniques to render the images of the set S, as described more fully below with respect to FIGS. 6-8.

c. Facilitating Receipt of a Subset of Images in Set S

Referring now to FIG. 6, a graphical representation illustrating a sparse representation of volume 3 consisting of one or more reduced-quality images according to an exemplary embodiment is provided. In this regard, the MPR renderer 78 may utilize a spare representation or a subset of the images of volume 3 to facilitate receipt of reduced-quality images (also referred to herein as low-fidelity images) which may result in preview-quality MPR rendering corresponding to images of a preview quality. As described above, preview quality images may be manipulated and used for navigation purposes as well as any other suitable purposes. In an exemplary embodiment, the reduced-quality images may be lossy compressed images. However, it should be pointed out that the reduced-quality images may any other suitable images in which at least a portion of the original data of the images is reduced. By reducing a portion of the original data of the images such as for example images I₁, I₂, I₃, I₄, I₅, I₆, I₇ and/or I₈, the reduced-quality images may be transferred to a computing device 100 faster than in instances in which images include all of their original data. In this regard, a user of computing device 100 may preview one or more images associated with an MPR in a fast manner.

Given a parameter n as the number of images in set S, the sparse representation Sₛ of volume 3 may be defined as Sₛ={I_{1+k*p}|k=maximum (d+1, n/m), dεN, pεN, k*p<n} (equation 1) where:

S={Iₓ|1<=x<=n},

d denotes the minimum distance, in terms of skipped images, between two successive elements of Sₛ,
m is the maximum number of images to be included in Sₛ,
N represents a set of nonnegative integers (e.g., 0, 1, 2, 3, etc.), in which dεN denotes that parameter d belongs to N, and
p denotes a set of nonnegative integers, in which pεN denotes that parameter p belongs to N.

As an example of the manner in which the MPR renderer 78 may utilize equation 1 to generate a spares set Sₛ, consider a scenario in which a user may utilize a user input interface 82 to select one or more images of a dataset such as for example set S. (In an alternative exemplary embodiment, a user may also utilize the user input interface 82 to specify that a reduced-quality version of the selected images is acceptable.) For purposes of illustration and not of limitation also consider that n=8, d=2 and m=10 in this example. In this regard, the MPR renderer 78 may determine that k equals the maximum of (d+1, n/m) and as such k equals 3 in this example since the maximum of (2+1, 8/10) is taken as the value of k. As described above, parameter p equals a set of nonnegative integers (e.g., 0, 1, 2, 3, etc.) belonging to N. As such, Sₛ=I_{1+3*0} which equals I₁ when p=0. Moreover, when p=1, Sₛ=I_{1+3*1} which equals I₄ and when p=2, Sₛ=I_{1+3*2} which equals I₇. It should be pointed out that the MPR renderer 78 may determine that no more images of the set S may be included in the sparse set Sₛ in this example when p=4 since k*p<n, and in this example 2*4 equals 8 which is not less than n (e.g., 8).

In this regard, the MPR renderer 78 may determine that the sparse set of images Sₛ={I₁, I₄, I₇}. As such, the MPR renderer 78 may send a request to a device such as communication device 145 to send the subset of images I₁, I₄, and I₇ of the dataset such as set S for rendering and display on a computing device 100. The images I₁, I₄, and I₇ may be reduced-quality images for manipulation and navigation purposes. The MPR renderer 78 may subsequently receive the remainder of the images of the set S from a communication device 145 in a sequential or progressive manner and may render and facilitate display of the remainder of images via display 80, as described more fully below.

It should also be pointed out that when corresponding improved-quality images are received by a computing device 100 from the communication device 145, the MPR renderer 78 may replace the reduced-quality images with corresponding improved-quality images. The improved-quality images may include all of the original data associated with the images and may not be compressed. Additionally, the MPR renderer 78 may select the best-available-quality images to replace the improved-quality images for diagnostic purposes.

In the exemplary embodiment of FIG. 5, it should be pointed out that the images I₁, I₄, and I₇ may include visible indicia (e.g., a color, which may for e.g., be denoted by the darker dots of I₁, I₄, I₇) denoting that these are images that are part of the sparse set Sₛ are to be sent to a computing device 100 before the remainder of the images of the set S. It should be pointed out that by configuring the parameters m and d, the MPR renderer 78 may balance the quality of a preview MPR rendering versus the time required to transfer the sparse set Sₛ to a computing device 100. In this regard, the parameter m may be used to limit the maximum number of images composing the sparse set Sₛ and as such the sparse set Sₛ may be transferred within a certain set time interval (e.g., two seconds) over an available network connection (e.g., a connection with network 140 via communication interface 88). The parameter d may define the maximum density of sparse set Sₛ in relation to the original set S, without consideration to the time required to transfer sparse set Sₛ or set S. For example, a parameter of d=1 may signify that sparse set Sₛ may include at most half of the images in set S.

d. Order of Transferring Images of a Set S

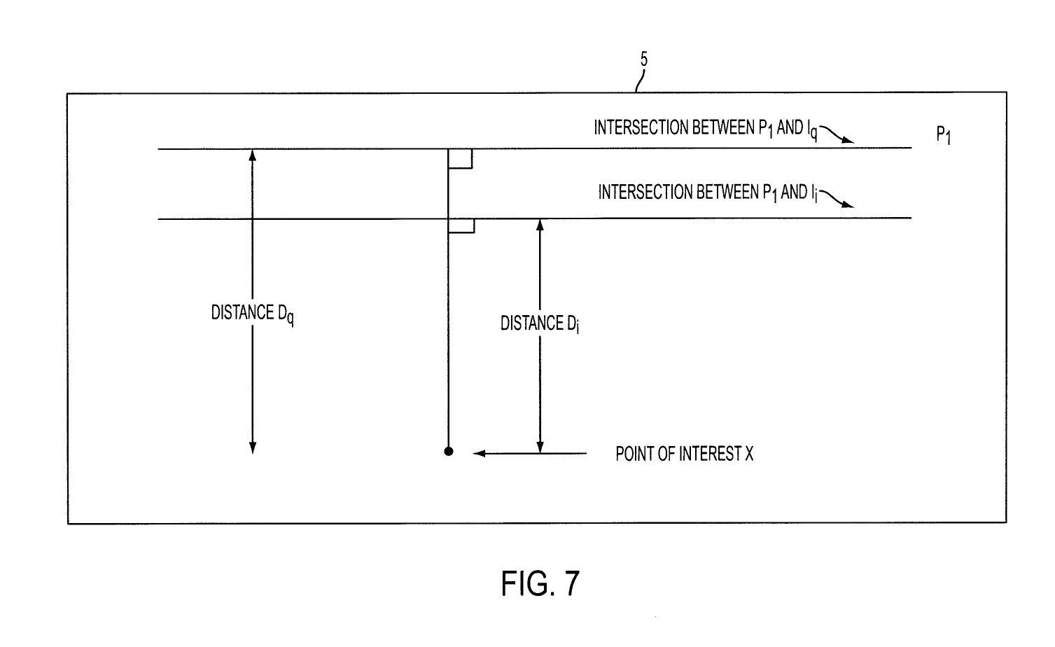

Referring now to FIGS. 7 & 8, a mechanism for generating an order in which to transfer one or more images of a dataset according to an exemplary embodiment is provided. As described above, after the subset of images of sparse set Sₛ are received by a computing device 100 and rendered by the MPR renderer 78 for display, the images (e.g., all of the images) of the set S may be received by a respective computing device 100 from communication device 145. The images of the set S may be received in a high quality (e.g., improved-quality images or diagnostic quality images). As also described above, the MPR renderer 78 may replace reduced-quality images (e.g., reduced-quality images of the sparse set Sₛ) received by the respective computing device 100 from communication device 145 with corresponding high quality images (e.g., of the set S). In this regard, full quality images of set S may be received by a computing device 100.

However, it should be pointed out that the MPR renderer 78 may facilitate the transfer of the images (e.g., medical images such as, for e.g., DICOM images) of set S, from communication device 145, in a certain order based in part on a point(s)-of-interest chosen or selected by a user. For instance, given XεP₁ (equation 2) in which a user defined or selected point-of-interest X belongs to a plane P₁ (e.g., plane 5), Dᵢ is the distance between point(s)-of-interest X and the intersection between P₁ and an image Iᵢ as shown in FIG. 7. For any two images Iᵢ, I_{q}εS (equation 3) which denotes two images belonging to set S, the MPR renderer 78 may request that a device such as communication device 145 transfer image Iᵢ before image I_{q} if and only if Dᵢ<D_{q}, where D_{q} is the distance between point(s)-of-interest X and the intersection between P₁ (e.g., plane 5) and an image I_{q}.

It should be pointed out that when Dᵢ=D_{q}, the MPR renderer 78 may request that a device such as, for example, communication device 145 transfer images Iᵢ and I_{q} at the same time. However, in an alternative exemplary embodiment, when Dᵢ=D_{q}, the MPR renderer 78 may determine that while images Iᵢ and I_{q} may be transferred at the same time, the MPR renderer 78 may randomly select either image Iᵢ or image I_{q} to be transferred first since the distances (e.g., Dᵢ and D_{q}) between the intersection P₁ (e.g., plane 5) and the images Iᵢ and I_{q} may be the same in this example. In this regard, the MPR renderer 78 may determine that the randomly selected image (e.g., image Iᵢ) is to be transferred first followed by the transfer of the non-selected image (e.g., image I_{q}).

As such, images that are closest (e.g., image Iᵢ) to a user defined or selected point(s)-of-interest X may be transferred by the communication device 145 to a computing device 100 before images (e.g., image I_{q}) that are farther away from point(s)-of-interest X. In this regard, the images that are in a proximity of a point(s)-of-interest (e.g., point(s)-of-interest X) may be prioritized by the MPR renderer 78 and the images in the proximity may be transferred from a communication device 145 and received by a respective computing device in a high quality or best-available-quality such as a diagnostic quality which may include all of the original data associated with the respective images. In this regard, the MPR renderer 78 may send a request to communication device 145 to transfer or send images to the computing device 100 that are closer to the point(s)-of-interest X before images situated farther from point(s)-of-interest X. As such, the MPR renderer 78 may increase the density of the images in the proximity of the point(s)-of-interest at a greater rate than the density of peripheral areas of the images. In this regard, a user of a respective computing device 100 may begin diagnosing images before the entire dataset of high quality images are received.

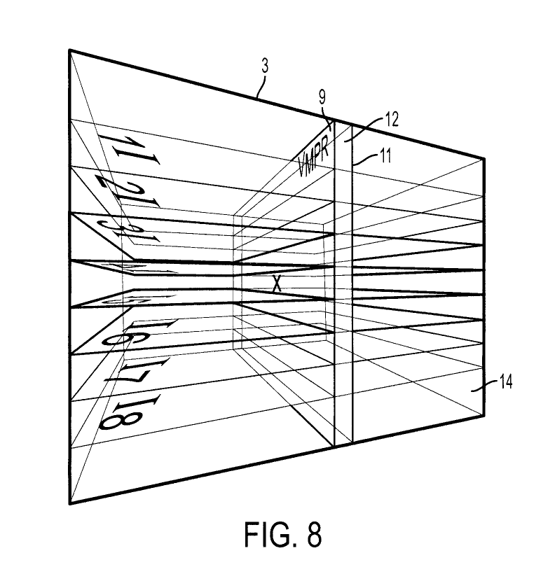

Referring now to FIG. 8, a graphical representation of an order (also referred to herein as transfer order) in which one or images of a dataset may be transferred to a computing device 100 according to an exemplary embodiment is provided. It should be pointed out that the MPR renderer 78 may generate a request (e.g., transfer order) for the transfer of one or more images in a given order based in part on a user defined or selected point(s)-of-interest X. The request generated by the MPR renderer 78 may be sent to the communication device 145 so that the communication device 145 may send a respective computing device 100 the images in an order (e.g., sequential order) specified by the request.

In the example of FIG. 8, the MPR renderer 78 may utilize equations 2 and 3 to determine that the images I₄ and I₅ are the closest to point(s)-of-interest X and that images I₄ and I₅ are an equal distance (e.g., distance D₄=distance D₅) away from point(s)-of-interest X. As such, the MPR renderer 78 may generate a request that may be sent to communication device 145 requesting the communication device 145 to transfer or send images I₄ and I₅ to a respective computing device 100 at the same time. Alternatively, the MPR renderer 78 may randomly select either one of the images I₄ and I₅ to be transferred first (e.g., image I₄) followed by the transfer of the non-selected image (e.g., image I₅) since the distances D₄ and D₅ may be the same. In this regard, the MPR renderer 78 may include information in the request that may be sent to the communication device 145 requesting transfer of the selected image (e.g., image I₄) followed by transfer of the non-selected image (e.g., image I₅).

Subsequently, the MPR renderer 78 may utilize equations 2 and 3 to determine that the images I₃ and I₆ are the next closest images to point(s)-of-interest X and that images I₃ and I₆ are an equal distance (e.g., distance D₃=distance D₆) away from point(s)-of-interest X. In this regard, the MPR renderer 78 may generate a request that may be sent to communication device 145 requesting the communication device 145 to transfer or send images I₃ and I₆ to a respective computing device 100 at the same time. Alternatively, the MPR renderer 78 may randomly select either one of the images I₃ and I₆ to be transferred first (e.g., image I₃) followed by the transfer of the non-selected image (e.g., image I₆) since the distances D₃ and D₆ may be the same. In this regard, the MPR renderer 78 may include information in the request that may be sent to the communication device 145 requesting transfer of the selected image (e.g., image I₃) followed by transfer of the non-selected image (e.g., image I₆) to the respective computing device 100.

Thereafter, the MPR renderer 78 may utilize equations 2 and 3 to determine that the images I₂ and I₇ are the next closest images to point(s)-of-interest X and that images I₂ and I₇ are an equal distance (e.g., distance D₂=distance D₇) away from point(s)-of-interest X. In this regard, the MPR renderer 78 may generate a request that may be sent to communication device 145 requesting the communication device 145 to transfer or send images I₂ and I₇ to a respective computing device 100 at the same time. Alternatively, the MPR renderer 78 may randomly select either one of the images I₂ and I₇ to be transferred first (e.g., image I₂) followed by the transfer of the non-selected image (e.g., image I₇) since the distances D₂ and D₇ may be the same. As such, the MPR renderer 78 may include information in the request that may be sent to the communication device 145 requesting transfer of the selected image (e.g., image I₂) followed by transfer of the non-selected image (e.g., image I₇) to the respective computing device 100.

Subsequently, the MPR renderer 78 may utilize equations 2 and 3 to determine that the images I₁ and I₈ are the next closest images to point(s)-of-interest X and that images Iᵢ and I₈ are an equal distance (e.g., distance D₁=distance D₈) away from point(s)-of-interest X. It should be pointed out that in the this example, the MPR renderer 78 may determine that the images I₁ and I₈ are the farthest images away from point(s)-of-interest X and as such the images I₁ and I₈ may be the last images transferred. In this regard, the MPR renderer 78 may generate a request that may be sent to communication device 145 requesting the communication device 145 to transfer or send images I₁ and I₈ to a respective computing device 100 at the same time. Alternatively, the MPR renderer 78 may randomly select either one of the images I₁ and I₈ to be transferred first (e.g., image I₁) followed by the transfer of the non-selected image (e.g., image I₈) since the distances D₁ and D₈ may be the same. As such, the MPR renderer 78 may include information in the request that may be sent to the communication device 145 requesting transfer of the selected image (e.g., image I₁) followed by transfer of the non-selected image (e.g., image I₈) to the respective computing device 100.

By requesting transfer, by the MPR renderer 78, of the images closest to a user defined or point(s)-of-interest selected by a user (e.g., physician), the user may begin diagnosing areas of interest with respect to the images prior to the entire transfer of a dataset of images (e.g., set S). In this regard, the exemplary embodiments facilitate an efficient and reliable manner in which to transfer images of a dataset to a device for usage by a user (e.g., a physician).

Additionally, it should be pointed out that the MPR renderer 78 may track a position of a point(s)-of-interest during the transfer of the images of a dataset (e.g., set S) by the communication device 145 to a respective computing device 100. In this regard, when the MPR renderer 78 determines that the position of a point(s)-of-interest is changed, the MPR renderer 78 may dynamically change or adjust the order in which the images are to be sent to the respective computing device 100 from the communication device 145. It should be pointed out that the MPR renderer 78 may detect that a point(s)-of-interest is changed based on an input or selection for a different or new point(s)-of-interest chosen by a user utilizing the user input interface 82 of a respective computing device 100.

The changed or adjusted order may be sent to the communication device 145 in a request that includes information specifying the order in which the images are to be transferred to the respective computing device 100 based on the changed point(s)-of-interest. The adjusted or changed order may be generated by the MPR renderer 78 based on the images that are closest to the changed point(s)-of-interest (that may be tracked or detected by the MPR renderer 78) in a manner analogous to that described above with respect to FIG. 8. For instance, by the MPR renderer 78, utilizing, in part, equations 2 and 3 and based on a different or new point(s)-of-interest.

e. Mechanism of Receiving Images of a Dataset & Rendering Images for Display

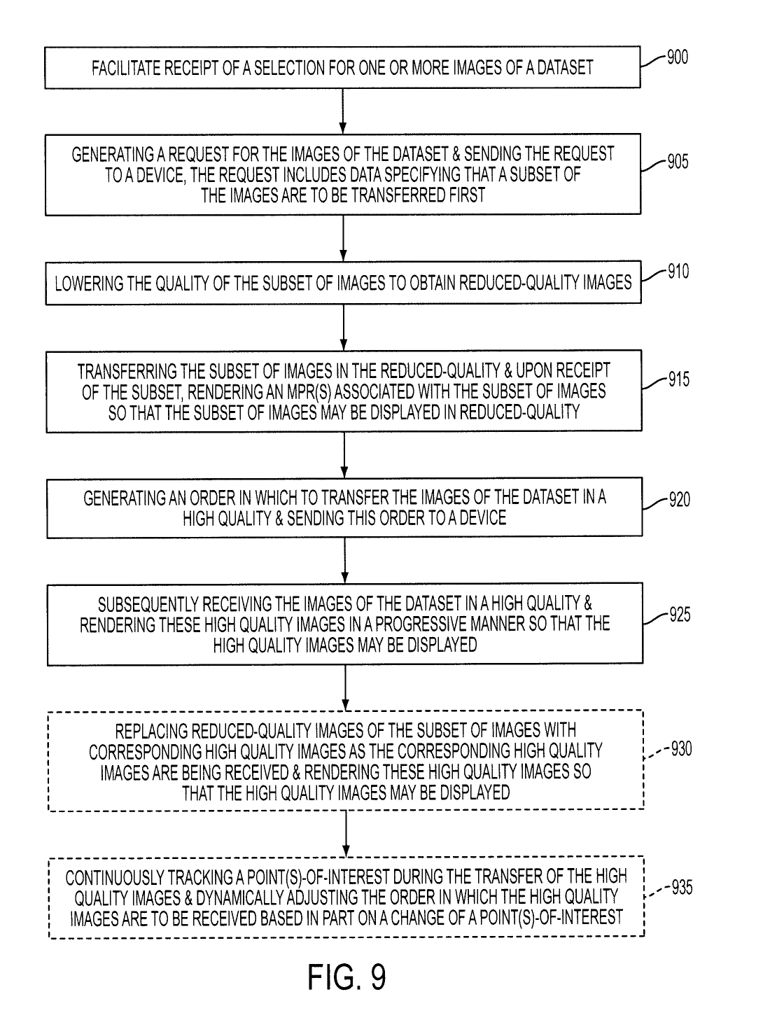

Referring now to FIG. 9, a flowchart of an exemplary method for facilitating transfer and receipt of one or more images of a dataset and rendering the images for display is provided. At operation 900, the MPR renderer 78 may receive a selection for one or more images of a dataset (e.g., images of set S, such as, for e.g., DIACOM images). The images may be part of a three-dimensional volume (e.g., three-dimensional volume 3). In an exemplary embodiment, the MPR renderer 78 may receive a selection for one or more images via user input interface (e.g., user input interface 82). At operation 905, the MPR renderer 78 may generate a request for the images of the dataset and may send a request to a device such as for example communication device 145. The request may include data specifying that a subset of images are to be transferred first to a corresponding computing device 100. In an exemplary embodiment, the subset of images may correspond to a sparse set Sₛ as defined by equation 1 and the MPR renderer 78 may utilize equation 1 to determine the subset of images that are to be transferred to the respective computing device 100. The request may also include data specifying that the images of the dataset are to have a reduced-quality.

At operation 910, a processor (e.g., processor 34) of a device, such as for example communication device 145 may lower the quality of the subset of images to obtain reduced-quality images. In an exemplary embodiment, the reduced-quality images may be images having a preview quality in which at least a portion of the original data of the subset of images may be compressed (e.g., via lossy compression). The reduced-quality images may be used for manipulation of the images and navigation purposes, in the manner described above. At operation 915, a processor (e.g., processor 34) of a device such as, for example, communication device 145 may transfer the subset of images (e.g., images of sparse set Sₛ) in the reduced-quality to a respective computing device 100. Upon receipt of the subset of images by the respective computing device 100, the MPR renderer 78 may render a multi-planar reconstruction associated with the subset of images and instruct a display (e.g., display 80) to show the subset of images in a reduced-quality (e.g., preview-quality). In an exemplary embodiment, the subset of images may, but need not, be shown in two-dimensions.

At operation 920, the MPR renderer 78 may generate an order in which all of the images of the dataset (e.g., set S) may be transferred by a device such as, for example, communication device 145, to a respective computing device 100. The MPR renderer 78 may send the generated order in a request to a device such as, for example, communication device 145 instructing the communication device 145 to send the images of the dataset to a respective computing device 100 in a sequence as specified by the order. The request generated by the MPR renderer 78 may also include information specifying that the images are to be transferred or sent to the respective computing device 100 in a high quality (e.g., diagnostic quality). It should be pointed out that the order generated by the MPR renderer 78 may be based in part on a point(s)-of-interest (e.g., point(s)-of-interest X, see e.g., FIG. 8) and the proximity of one or more images to the point(s)-of-interest relative to a given plane (e.g., plane 5, (e.g., plane P₁)). In particular, the MPR renderer 78 may utilize equations 2 and 3 to generate the order, in a manner analogous to that described above.

In this regard, the MPR renderer 78 may increase the density of the images in the proximity of the point(s)-of-interest at a greater rate than the density of peripheral areas of the images. As such, a user of a respective computing device 100 may begin diagnosing images before the entire dataset of high quality images are received.

At operation 925, the respective computing device 100 may subsequently receive the images of the dataset (e.g., all of the images of the set S) from a device such as, for example, communication device 145. The images of the dataset may be received by the respective computing device 100 in a high quality (e.g., diagnostic quality). It should also be pointed out that the images of the dataset may be received in a progressive manner and may be rendered by the MPR renderer 78 which may instruct a display (e.g., display 80) to show the images. In an exemplary embodiment, the images of the dataset may, but need not, be displayed in two-dimensions.

Optionally, at operation 930, the MPR renderer 78 may replace the reduced-quality images (e.g., the reduced quality images of sparse set Sₛ) that were rendered and displayed during operation 915 with corresponding high quality images of the dataset as the corresponding high quality images are being received from a device such as, for example, communication device 145, in the sequence specified by the order. In this regard, the MPR renderer 78 may render the high quality images that may replace the reduced-quality images in a progressive manner and may instruct a display (e.g., display 80) to show the high quality images. As an example, the MPR renderer 78 may replace the reduced-quality images I₁, I₄, I₇ of sparse set Sₛ described above with corresponding high quality images of I₁, I₄, I₇ of set S. The high quality images that may replace the reduced-quality images may, but need not, be displayed in two-dimensions.

Optionally, at operation 935, the MPR renderer 78 may continuously track or monitor a point(s)-of-interest during the transfer of the high quality images and may dynamically change the order in which the high quality images are to be transferred by a device such as, for example, communication device 145 and received by a respective computing device 100 based in part on a change in the point(s)-of-interest, in the manner described above.

It should be pointed out that FIG. 9 is a flowchart of a system, method and computer program product according to exemplary embodiments of the invention. It will be understood that each block or step of the flowcharts, and combinations of blocks in the flowcharts, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory 86) and executed by a processor (e.g., processor 70, MPR renderer 78, processor 34). As will be appreciated, any such computer program instructions may be loaded onto a computer or other programmable apparatus (e.g., hardware) to produce a machine, such that the instructions which execute on the computer or other programmable apparatus cause the functions specified in the flowchart blocks or steps to be implemented. In some embodiments, the computer program instructions are stored in a computer-readable memory that can direct a computer or other programmable apparatus to function in a particular manner, such that the instructions stored in the computer-readable memory produce an article of manufacture including instructions which implement the function specified in the flowchart blocks or steps. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart blocks or steps.

Accordingly, blocks or steps of the flowchart support combinations of means for performing the specified functions and combinations of steps for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In an exemplary embodiment, an apparatus for performing the method of FIG. 9 above may comprise a processor (e.g., the processor 70, MPR renderer 78s) configured to perform some or each of the operations described above. The processor may, for example, be configured to perform the operations by performing hardware implemented logical functions, executing stored instructions, or executing algorithms for performing each of the operations. Alternatively, the apparatus may comprise means for performing each of the operations described above. In this regard, according to an example embodiment, examples of means for performing operations may comprise, for example, the processor 70 (e.g., as means for performing any of the operations described above), the MPR renderer 78, processor 34 and/or a device or circuit for executing instructions or executing an algorithm for processing information as described above.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving a selection for one or more medical images of a set of medical images;
sending a request to a device for transfer of the medical images of the set, the request comprises information instructing the device to transfer a subset of the medical images of the set first;
receiving the subset of medical images in a reduced-quality based on information in the request and displaying the subset of medical images in the reduced-quality;
subsequently receiving each of the medical images of the set in a high quality based on an order specifying a sequence in which the medical images of the set are to be transferred; and
displaying the medical images of the set in the high quality.

2. The method of claim 1, further comprising generating the order based in part on a distance between at least one point-of-interest selected by a user and an intersection between a plane and at least one medical image, the point-of-interest is associated with at least one medical image of the subset or the set.

3. The method of claim 1, further comprising transferring a first image before a second image in response to determining that a first distance between at least one point-of-interest selected by a user and a first intersection between a plane and the first image is less than a second distance between the point-of-interest and a second intersection between the plane and the second image.

4. The method of claim 1, further comprising replacing the subset of medical images in the reduced-quality with corresponding high quality medical images of the set.

5. The method of claim 1, wherein displaying further comprises rendering at least one multi-planar reconstruction associated with the medical images of the set to display the medical images of the set.

6. The method of claim 1, further comprising:
tracking or monitoring at least one point-of-interest selected by a user during the receipt of the medical images of the set; and
dynamically adjusting the order in response to determining that the point-of-interest is changed.

7. The method of claim 1, further comprising, determining the subset of medical images based in part on a number of medical images in the set, a minimum distance in terms of one or more skipped images between at least two successive images of a defined set of medical images and a maximum number of medical images for inclusion in the defined set.

8. The method of claim 7, further comprising, determining the subset of medical images based in part on a maximum of the distance with respect to the number of medical images divided by the maximum number of medical images.

9. The method of claim 1, further comprising:
utilizing at least one of the high quality images to diagnose a person prior to receipt of each of the medical images of the set, wherein the medical images of the subset and the medical images of the set are part of a three-dimensional volume.

10. The method of claim 2, further comprising:
increasing a density of medical images in a proximity of the point-of-interest at a rate greater than a density of medical images in areas that are peripheral to the proximity.

11. An apparatus comprising:
a processor configured to:
receive a selection for one or more medical images of a set of medical images;
send a request to a device for transfer of the medical images of the set, the request comprises information instructing the device to transfer a subset of the medical images of the set first;
receive the subset of images in a reduced-quality based on information in the request and displaying the subset of medical images in the reduced-quality;
subsequently receive the medical images of the set in a high quality based on an order specifying a sequence in which the medical images of the set are to be transferred; and
display the medical images of the set in the high quality.

12. The apparatus of claim 11, wherein the processor is further configured to generate the order based in part on a distance between at least one point-of-interest selected by a user and an intersection between a plane and at least one medical image, the point-of-interest is associated with at least one medical image of the subset or the set.

13. The apparatus of claim 11, wherein the processor is further configured to:
transfer a first image before a second image in response to determining that a first distance between at least one point-of-interest selected by a user and a first intersection between a plane and the first image is less than a second distance between the point-of-interest and a second intersection between the plane and the second image.

14. The apparatus of claim 11, wherein the processor is further configured to replace the subset of medical images in the reduced-quality with corresponding high quality medical images of the set.

15. The apparatus of claim 11, wherein the processor is further configured to display the medical images of the set by rendering at least one multi-planar reconstruction associated with the medical images of the set to display the medical images of the set.

16. The apparatus of claim 11, wherein the processor is further configured to:
track or monitor at least one point-of-interest selected by a user during the receipt of the medical images of the set; and
dynamically adjust the order in response to determining that the point-of-interest is changed.

17. The apparatus of claim 11, wherein the processor is further configured to determine the subset of medical images based in part on a number of medical images in the set, a minimum distance in terms of one or more skipped images between at least two successive images of a defined set of medical images and a maximum number of medical images for inclusion in the defined set.

18. The apparatus of claim 17, wherein the processor is further configured to determine the subset of medical images based in part on a maximum of the distance with respect to the number of medical images divided by the maximum number of medical images.

19. The apparatus of claim 11, wherein the processor is further configured to:
receive at least one of the high quality images for diagnosing a person prior to receipt of each of the medical images of the set, wherein the medical images of the subset and the medical images of the set are part of a three-dimensional volume.

20. The apparatus of claim 12, wherein the processor is further configured to increase a density of medical images in a proximity of the point-of-interest at a rate greater than a density of medical images in areas that are peripheral to the proximity.

21. A computer program product comprising at least one computer-readable storage medium having computer-executable program code instructions stored therein, the computer executable program code instructions comprising:
program code instructions for receiving a selection for one or more medical images of a set of medical images;
program code instructions for sending a request to a device for transfer of the medical images of the set, the request comprises information instructing the device to transfer a subset of the medical images of the set first;
program code instructions for receiving the subset of medical images in a reduced-quality based on information in the request and displaying the subset of medical images in the reduced-quality;
program code instructions for subsequently receiving the medical images of the set in a high quality based on an order specifying a sequence in which the medical images of the set are to be transferred; and
program code instructions for displaying the medical images of the set in the high quality.

22. The computer program product of claim 21, further comprising:
program code instructions for generating the order based in part on a distance between at least one point-of-interest selected by a user and an intersection between a plane and at least one medical image, the point-of-interest is associated with at least one image of the subset or the set.
